(19) United States
(12) Patent Application Publication
(10) Pub. No.: US 2014/0236869 A1
(43) Pub. Date: Aug. 21, 2014

(54) INTERACTIVE VARIABLE SELECTION DEVICE, INTERACTIVE VARIABLE SELECTION METHOD, AND INTERACTIVE VARIABLE SELECTION PROGRAM

(71) Applicant: NEC CORPORATION, Tokyo (JP)

(72) Inventors: Ryohei FUJIMAKI, Tokyo (JP); Satoshi MORINAGA, Tokyo (JP); Ji LIU, Madison, WI (US); Yoshinobu KAWAHARA, Osaka (JP)

(73) Assignee: NEC CORPORATION, Tokyo (JP)

(21) Appl. No.: 14/167,020

(22) Filed: Jan. 29, 2014

Related U.S. Application Data
(60) Provisional application No. 61/767,019, filed on Feb. 20, 2013.

(51) Int. Cl. G06N 5/00

(52) U.S. Cl. CPC G06N 5/00
USPC 706/11

(57) ABSTRACT

An optimality degree computation unit computes an optimality degree in the case where a first variable included in a variable set is a candidate for an addition variable, using an objective function. An addition threshold computation unit computes an addition threshold based on the computed optimality degree, the addition threshold being a threshold of the optimality degree and indicating a criterion for determining whether or not the first variable is to be set as the candidate for the addition variable. An objective function value computation unit computes an objective function value which is a difference between a value of the objective function computed using variables to be optimized and a value of the objective function computed using the variables to be optimized from which a second variable included in a nonzero variable set is excluded.

This application claims priority to U.S. Provisional Application No. 61/767,019 and filed Feb. 20, 2013, which is incorporated by reference.

### BACKGROUND OF THE INVENTION

1. Field of the Invention

The present invention relates to an interactive variable selection device, an interactive variable selection method, and an interactive variable selection program for selecting an optimal variable interactively with a user.

2. Description of the Related Art

A variable selection problem is an important basic technique in various fields of application such as machine learning, signal processing, pattern recognition, and financial engineering.

As an example, when modeling health risk scores by a logistic regression model and optimizing it, the model needs to be controlled so that only risk-contributing variables are selected while non-risk-contributing variables are zero.

As another example, when analyzing correlations in network traffic, analysis of a precision matrix (the inverse of a covariance matrix) is typically carried out. Upon computing the precision matrix, the problem needs to be solved with a constraint that variables that are truly not in dependency relationships are zero. This can be treated as a variable selection problem.

For a large-scale problem with a large number of variables, mechanical assistance is crucial because it is hard for a user to manually select variables. To provide such assistance, two main types of techniques have typically been proposed.

One technique is a technique (feature selection, attribute selection) of automatically selecting variables optimally from data by a machine. An example of this technique is a method based on convex optimization (e.g. linear regression model optimization having a sparsity constraint (lasso, see Non Patent Literature (NPL) 1), logistic regression model optimization (L1 logistic regression, see NPL 2), precision matrix optimization (graph lasso, see NPL 3)). Another example of this technique is a method based on greedy search (e.g. orthogonal matching pursuit (OMP, see NPL 4), forward-backward greedy search (FoBa, see NPL 5 and NPL 6)).

The other technique is a technique in which variables are scored or ordered by a machine and, based on these results, variables are selected by a user interactively.

### CITATION LIST

### Non Patent Literature(s)

NPL 1: Tibshirani, R. (1996) Regression shrinkage and selection via the lasso. Journal of the Royal Statistical Society, B 58, 267-288, 2007.

NPL 2: Ng, A. Y. 2004. Feature selection, l1 vs. l2 regularization, and rotational invariance. In Proceedings of International Conference on Machine Learning, 2004.

NPL 3: Jerome Friedman, Trevor Hastie, and Robert Tibshirani. Sparse inverse covariance estimation with the graphical lasso. Biostatistics, 9:432-441, 2007.

NPL 4: Zhang, T. Sparse recovery with orthogonal matching pursuit under rip. IEEE Transactions on Information Theory, 57(9):6215-6221, 2011.

NPL 5: Zhang, T. Adaptive forward-backward greedy algorithm for learning sparse representations. IEEE Transactions on Information Theory, 57(7):4689-4708, 2011.

NPL 6: Jalali, A., Johnson, C. C., and Ravikumar, P. D. On learning discrete graphical models using greedy methods. Neural Information Processing Systems, 2011.

### SUMMARY OF THE INVENTION

An exemplary object of the present invention is to provide an interactive variable selection device, an interactive variable selection method, and an interactive variable selection program that enable a user to select a more optimal variable from a plurality of selection candidates.

An exemplary aspect of the present invention is an interactive variable selection device for selecting a variable interactively with a user, the interactive variable selection device including: an addition variable candidate computation unit for computing candidates for an addition variable which is a variable to be added from a variable set to a nonzero variable set; an optimal variable selection update unit for updating variables to be optimized, by minimizing, for variables included in the nonzero variable set, an objective function that takes a minimum value in optimized variables; a deletion variable candidate computation unit for computing candidates for a deletion variable which is a variable to be deleted from the nonzero variable set; and a variable selection result output unit for outputting at least one of: the candidates for the addition variable; and the candidates for the deletion variable, wherein the addition variable candidate computation unit includes: an optimality degree computation unit for computing an optimality degree in the case where a first variable included in the variable set is a candidate for the addition variable, using the objective function; and an addition threshold computation unit for computing an addition threshold based on the computed optimality degree, the addition threshold being a threshold of the optimality degree and indicating a criterion for determining whether or not the first variable is to be set as the candidate for the addition variable, and wherein the deletion variable candidate computation unit includes: an objective function value computation unit for computing an objective function value which is a difference between a value of the objective function computed using the variables to be optimized and a value of the objective function computed using the variables to be optimized from which a second variable included in the nonzero variable set is excluded; and a deletion threshold computation unit for computing a deletion threshold based on the computed objective function value, the deletion threshold being a threshold of the objective function value and indicating a criterion for determining whether or not the second variable is to be deleted from the nonzero variable set.

An exemplary aspect of the present invention is an interactive variable selection method for selecting a variable interactively with a user, the interactive variable selection method including: computing candidates for an addition variable which is a variable to be added from a variable set to a nonzero variable set; updating variables to be optimized, by minimizing, for variables included in the nonzero variable set, an objective function that takes a minimum value in optimized variables; computing candidates for a deletion variable which is a variable to be deleted from the nonzero variable set; and outputting at least one of: the candidates for the addition variable; and the candidates for the deletion variable, wherein when computing the candidates for the addition variable, an optimality degree in the case where a first variable included in the variable set is a candidate for the addition variable is computed using the objective function, and an addition threshold is computed based on the computed optimality degree, the addition threshold being a threshold of the optimality degree and indicating a criterion for determining whether or not the first variable is to be set as the candidate for the addition variable, and wherein when computing the candidates for the deletion variable, an objective function value which is a difference between a value of the objective function computed using the variables to be optimized and a value of the objective function computed using the variables to be optimized from which a second variable included in the nonzero variable set is excluded is computed, and a deletion threshold is computed based on the computed objective function value, the deletion threshold being a threshold of the objective function value and indicating a criterion for determining whether or not the second variable is to be deleted from the nonzero variable set.

An exemplary aspect of the present invention is a non-transitory computer readable information recording medium storing an interactive variable selection program applied to a computer for selecting a variable interactively with a user, when executed by a processor, the interactive variable selection program performs a method for: computing candidates for an addition variable which is a variable to be added from a variable set to a nonzero variable set; updating variables to be optimized, by minimizing, for variables included in the nonzero variable set, an objective function that takes a minimum value in optimized variables; computing candidates for a deletion variable which is a variable to be deleted from the nonzero variable set; and outputting at least one of: the candidates for the addition variable; and the candidates for the deletion variable, wherein when computing the candidates for the addition variable, an optimality degree in the case where a first variable included in the variable set is a candidate for the addition variable is computed using the objective function, and an addition threshold is computed based on the computed optimality degree, the addition threshold being a threshold of the optimality degree and indicating a criterion for determining whether or not the first variable is to be set as the candidate for the addition variable, and wherein when computing the candidates for the deletion variable, an objective function value which is a difference between a value of the objective function computed using the variables to be optimized and a value of the objective function computed using the variables to be optimized from which a second variable included in the nonzero variable set is excluded is computed, and a deletion threshold is computed based on the computed objective function value, the deletion threshold being a threshold of the objective function value and indicating a criterion for determining whether or not the second variable is to be deleted from the nonzero variable set.

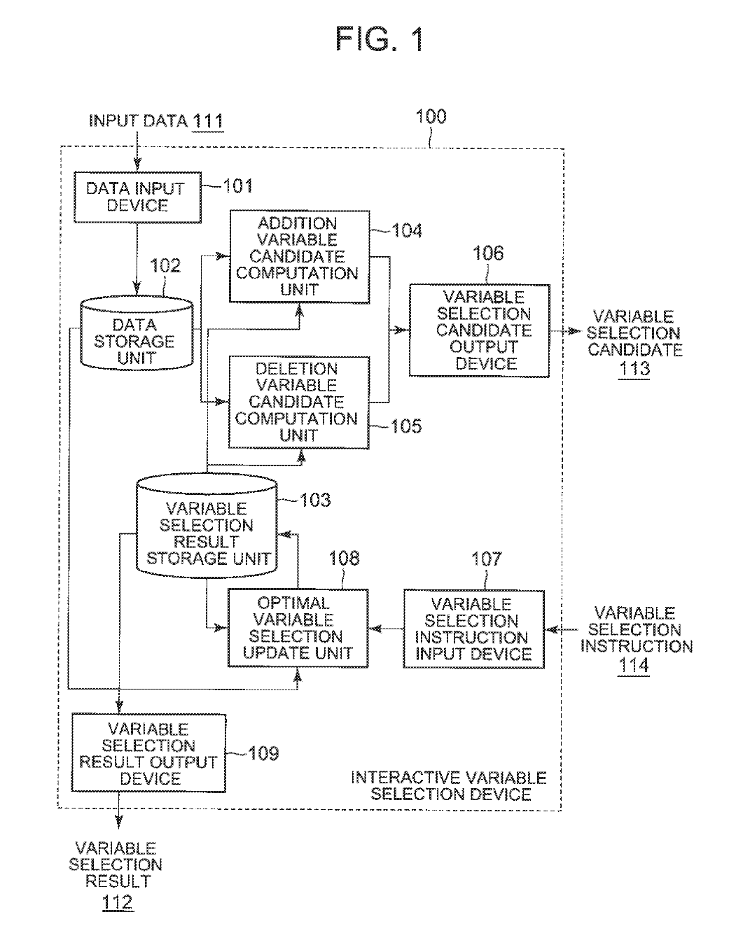

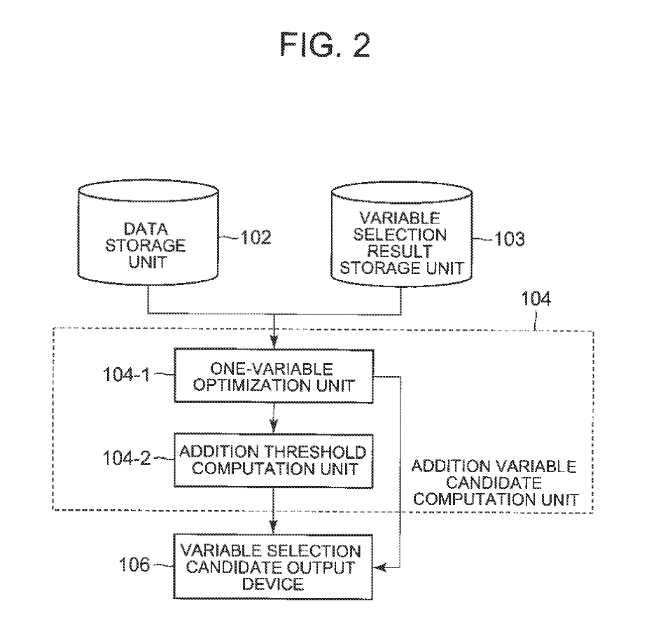

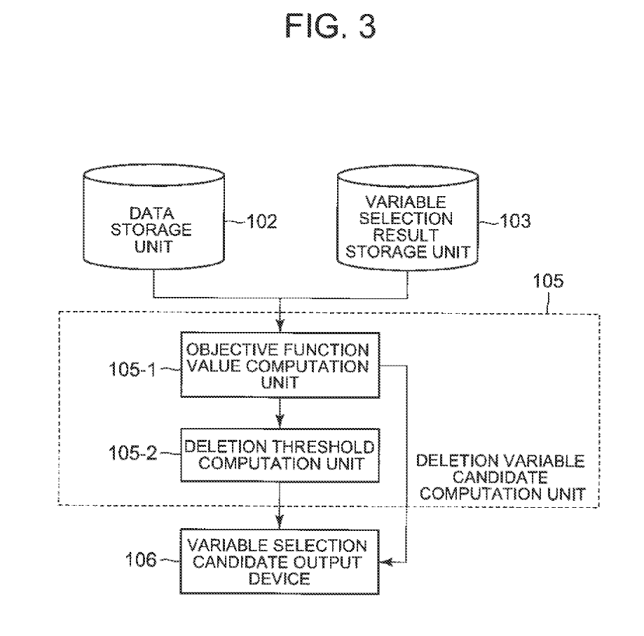

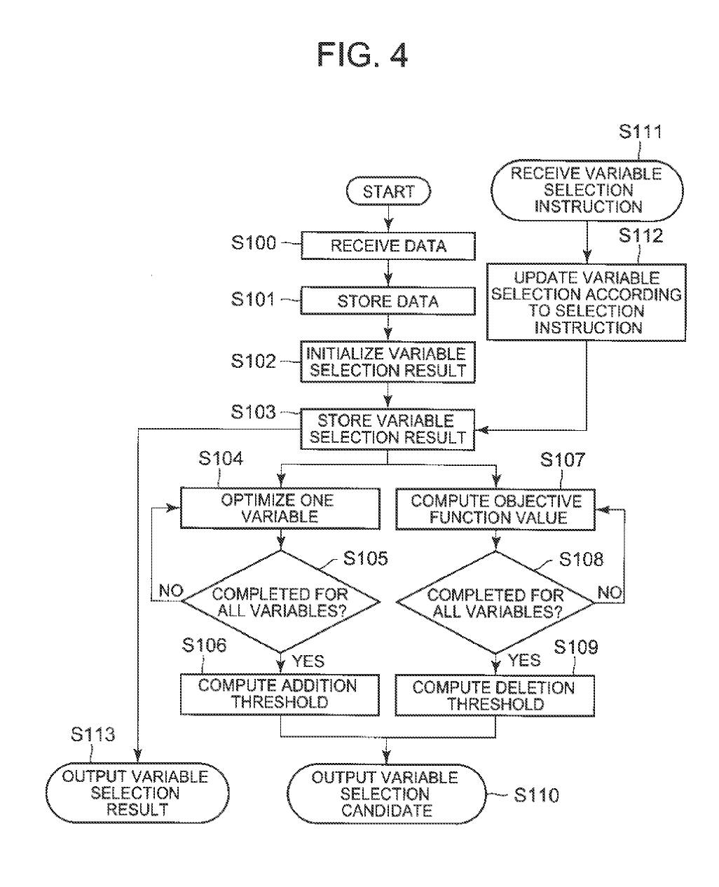

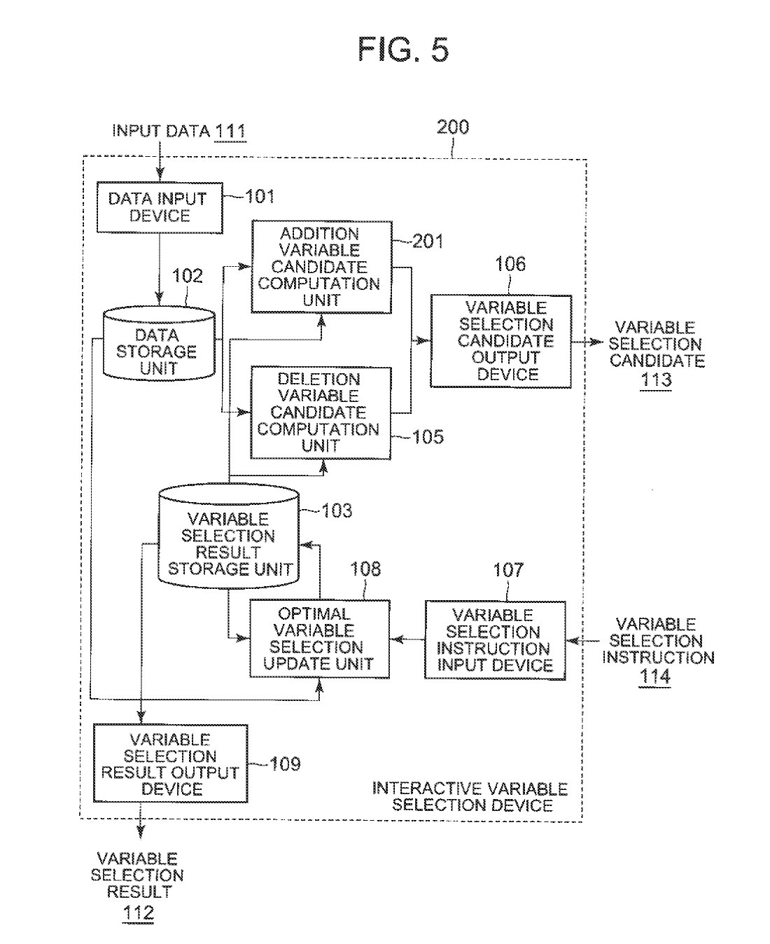

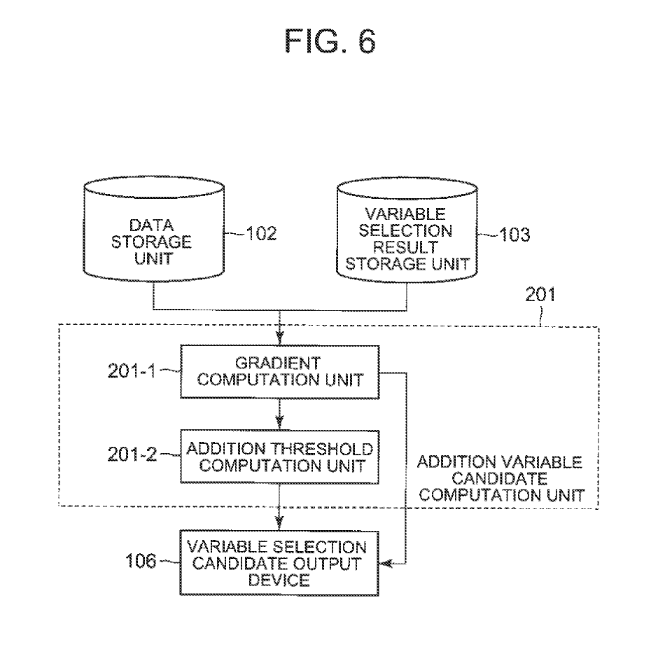

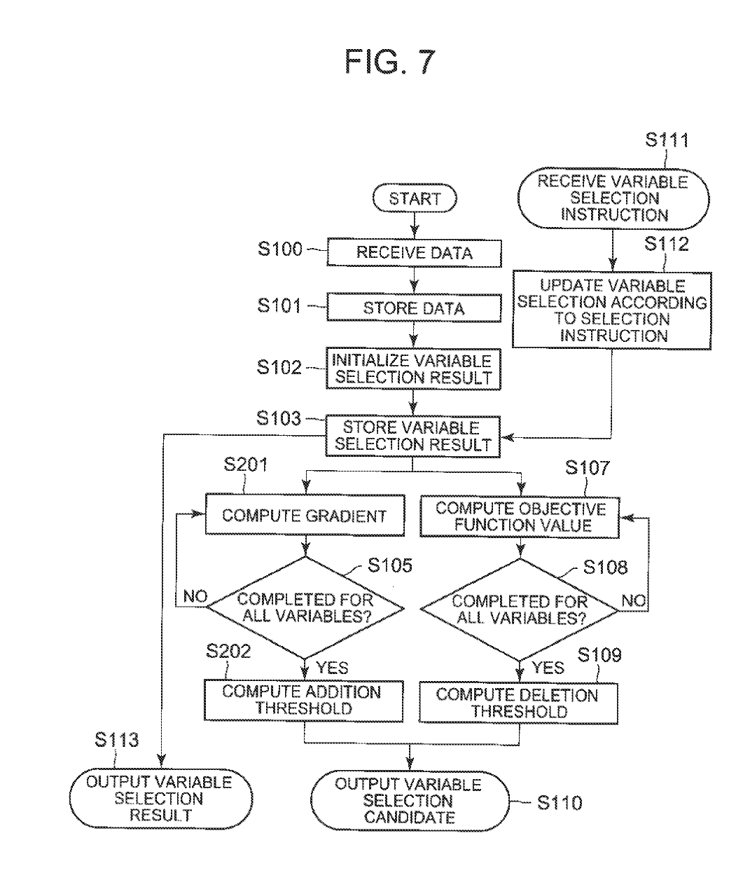

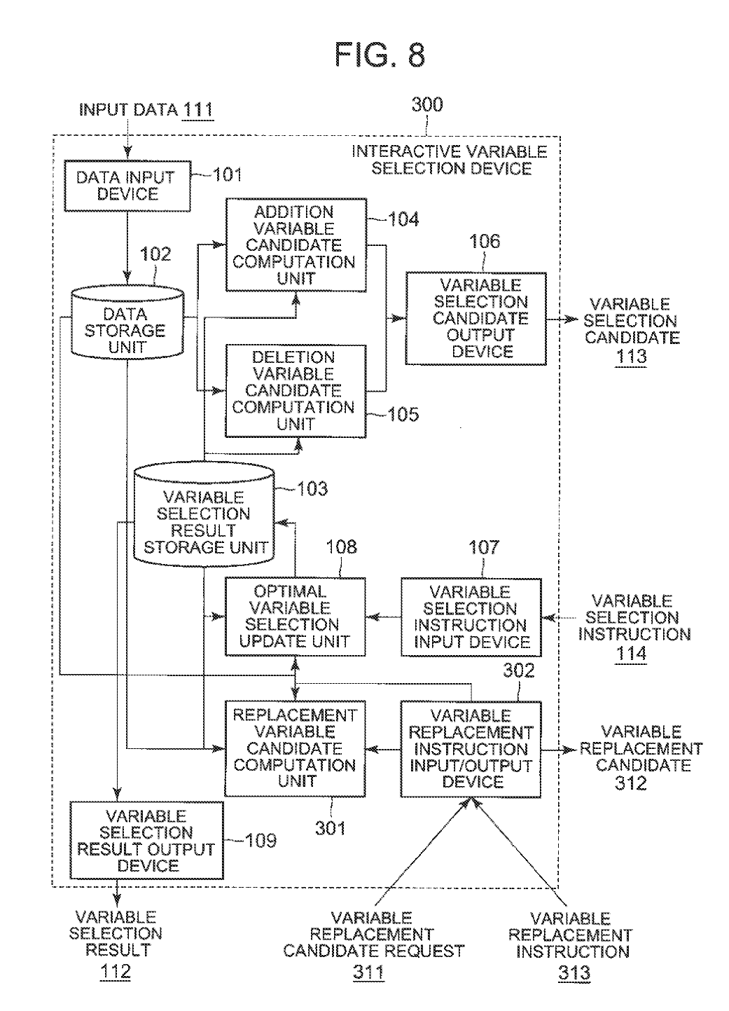

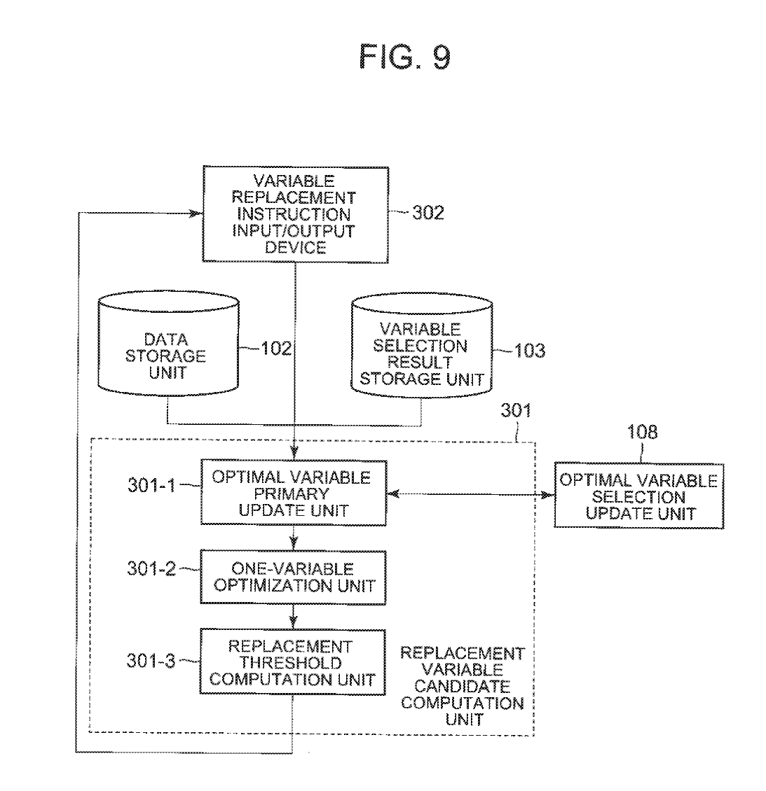

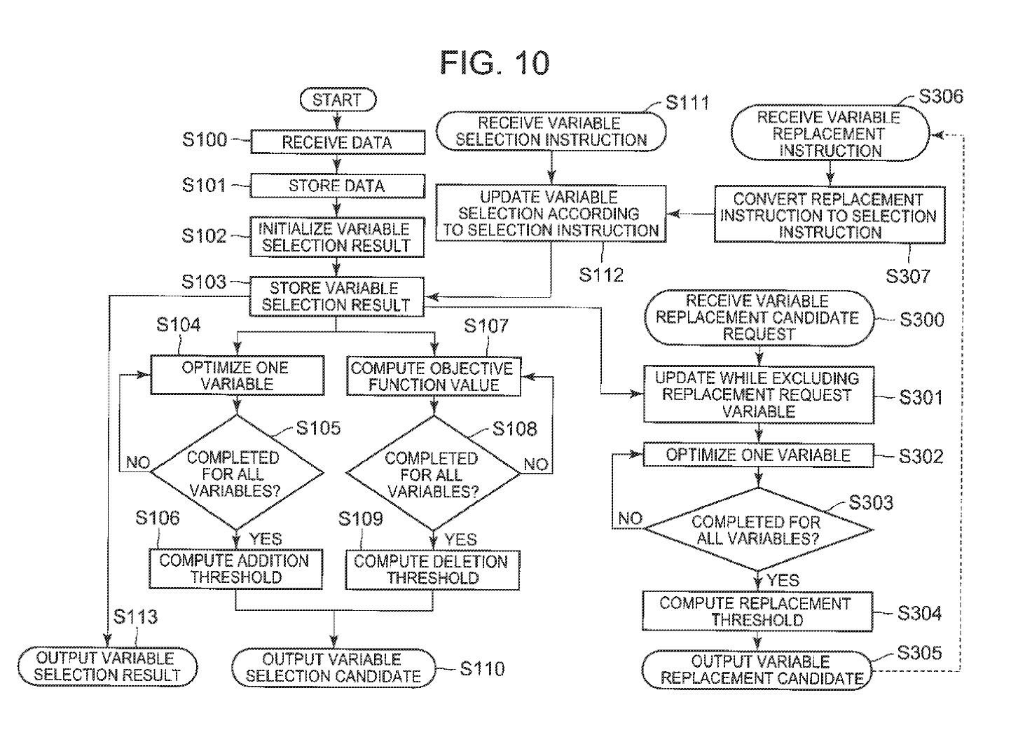

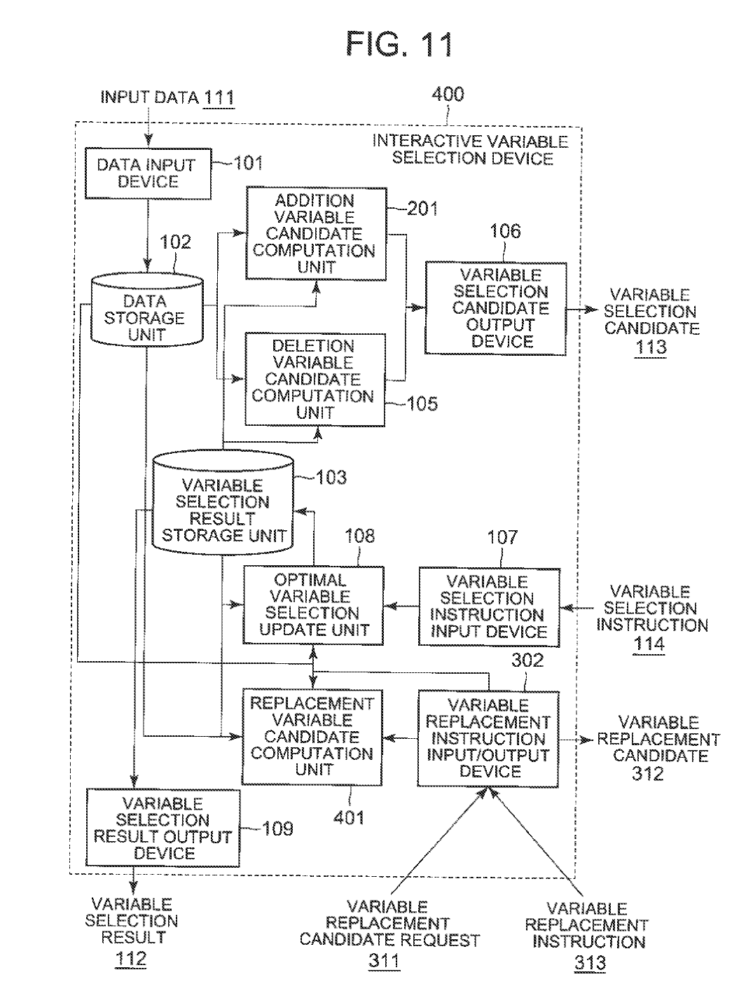

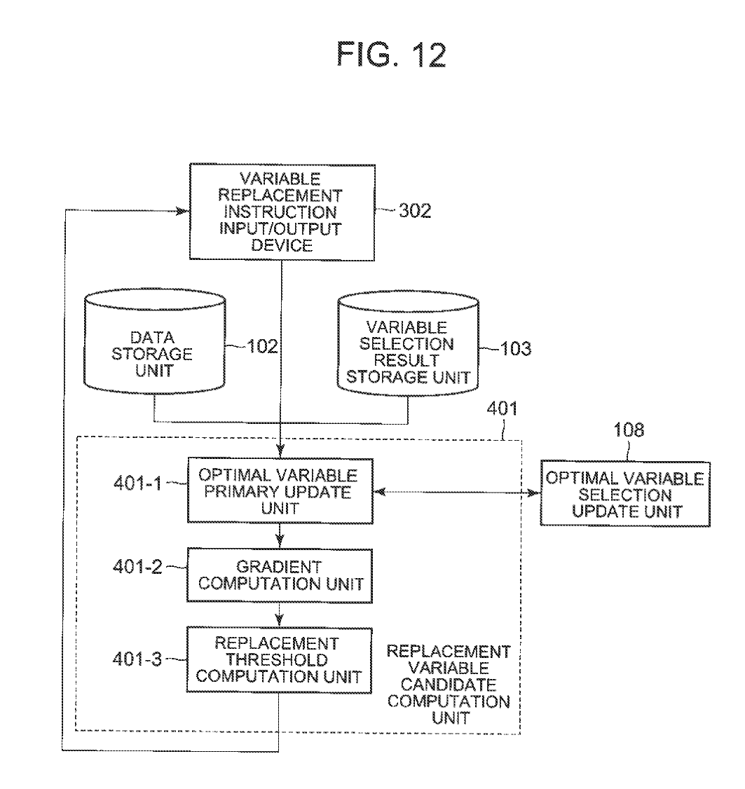

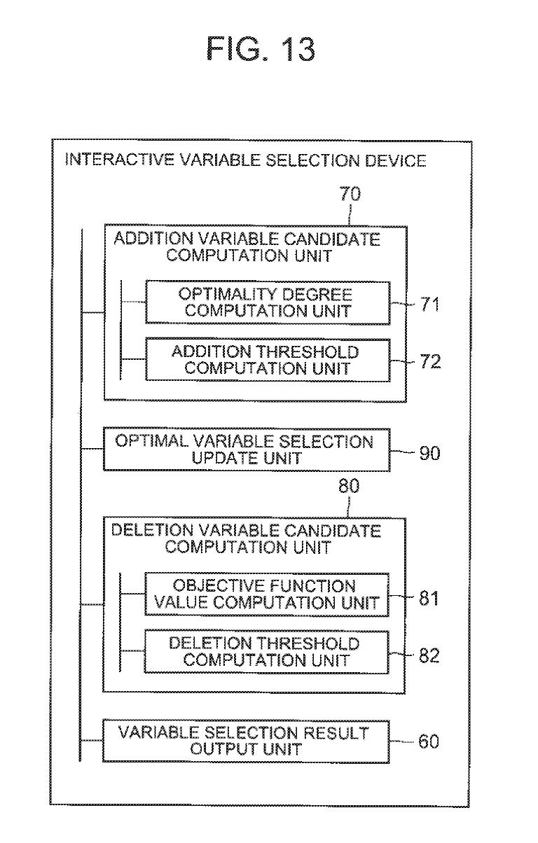

### BRIEF DESCRIPTION OF THE DRAWINGS

[FIG. 1] It is a block diagram depicting an example of a structure of Exemplary Embodiment 1 of an interactive variable selection device according to the present invention.

[FIG. 2] It is a block diagram depicting an example of a structure of an addition variable candidate computation unit 104 in Exemplary Embodiment 1.

[FIG. 3] It is a block diagram depicting an example of a structure of a deletion variable candidate computation unit 105 in Exemplary Embodiment 1.

[FIG. 4] It is a flowchart depicting an example of an operation of an interactive variable selection device 100 in Exemplary Embodiment 1.

[FIG. 5] It is a block diagram depicting an example of a structure of Exemplary Embodiment 2 of an interactive variable selection device according to the present invention.

[FIG. 6] It is a block diagram depicting an example of a structure of an addition variable candidate computation unit 201 in Exemplary Embodiment 2.

[FIG. 7] It is a flowchart depicting an example of an operation of an interactive variable selection device 200 in Exemplary Embodiment 2.

[FIG. 8] It is a block diagram depicting an example of a structure of Exemplary Embodiment 3 of an interactive variable selection device according to the present invention.

[FIG. 9] It is a block diagram depicting an example of a structure of a replacement variable candidate computation unit 301 in Exemplary Embodiment 3.

[FIG. 10] It is a flowchart depicting an example of an operation of an interactive variable selection device 300 in Exemplary Embodiment 3.

[FIG. 11] It is a block diagram depicting an example of a structure of Exemplary Embodiment 4 of an interactive variable selection device according to the present invention.

[FIG. 12] It is a block diagram depicting an example of a structure of a replacement variable candidate computation unit 401 in Exemplary Embodiment 4.

[FIG. 13] It is a block diagram depicting an overview of an interactive variable selection device according to the present invention.

### DESCRIPTION OF THE PREFERRED EMBODIMENTS

The following describes exemplary embodiments of the present invention with reference to drawings. The present invention relates to a technique of presenting ordered variables to a user to enable the user to select variables interactively.

Hereafter, variables to be optimized are denoted by w=(w1, . . . , wD), an objective function is denoted by f(w), a whole variable set is denoted by F, a current nonzero variable set is denoted by F(k), and a current variable pool (a set of variables with zero value which are not included in F(k) from among the variables included in F) is denoted by Fp(k).

Based on these denotations, a variable selection problem is typically written as

min_w f(w)

subject to |w|_{—}0≦K

where |w|_{—}0 is an L0 norm of w and indicates the number of nonzero elements, and K is an input parameter for controlling to what extent nonzero elements remain in the variables w to be optimized.

### Exemplary Embodiment 1

FIG. 1 is a block diagram depicting an example of a structure of Exemplary Embodiment 1 of an interactive variable selection device according to the present invention. An interactive variable selection device 100 in this exemplary embodiment includes a data input device 101, a data storage unit 102, a variable selection result storage unit 103, an addition variable candidate computation unit 104, a deletion variable candidate computation unit 105, a variable selection candidate output device 106, a variable selection instruction input device 107, an optimal variable selection update unit 108, and a variable selection result output device 109.

The interactive variable selection device 100 receives input data 111 and a variable selection instruction 114, and outputs a variable selection candidate 113 and a variable selection result 112.

The data input device 101 receives data and parameters necessary for variable selection. An example of the data necessary for variable selection is learning data necessary in the case of selecting variables using a logistic regression model of health risk scores mentioned earlier.

The data storage unit 102 stores the input data 111. The data storage unit 102 is realized, for example, by a magnetic disk or the like.

The variable selection result storage unit 103 stores F(k), Fp(k), w(k), and f(w(k)) as a variable selection result. Here, w(k) is an estimate of w corresponding to F(k). In an initial state, k=0, to initialize F(k) to an empty set, Fp(k) to all variables, and w(k) to a zero vector. The variable selection result storage unit 103 is realized, for example, by a magnetic disk or the like.

The addition variable candidate computation unit 104 computes candidates for a variable to be added to F(k) from among the variables included in Fp(k). In detail, in the case of adding one variable to F(k) from among the variables included in Fp(k), the addition variable candidate computation unit 104 computes candidates for the variable to be selected.

FIG. 2 is a block diagram depicting an example of a structure of the addition variable candidate computation unit 104 in this exemplary embodiment. The addition variable candidate computation unit 104 in this exemplary embodiment includes a one-variable optimization unit 104-1 and an addition threshold computation unit 104-2.

The one-variable optimization unit 104-1 optimizes the element of w corresponding to each variable included in Fp(k), while fixing F(k) and w(k). In detail, for the j-th variable, the one-variable optimization unit 104-1 solves a one-variable optimization problem of minimizing f(w) for wj. An objective variable value for the j-th variable is hereafter denoted by fj(w(k)). In this case, a variable corresponding to smaller fj(w(k)) has a higher possibility of reducing f(w) and so is more promising as a candidate for the variable to be added.

The addition threshold computation unit 104-2 computes a threshold indicating to what extent fj(w(k)) is small for the variable to be promising as an addition candidate. In detail, the addition threshold computation unit 104-2 computes the threshold by multiplying, by a parameter λwhere 0≦λ≦1, a mean value of higher-order (K−k) values of fj(w(k)) when arranged in ascending order.

The deletion variable candidate computation unit 105 computes candidates for a variable to be deleted from F(k). In detail, in the case of deleting one of the variables included in F(k), the deletion variable candidate computation unit 105 computes candidates for the variable to be selected.

FIG. 3 is a block diagram depicting an example of a structure of the deletion variable candidate computation unit 105 in this exemplary embodiment. The deletion variable candidate computation unit 105 in this exemplary embodiment includes an objective function value computation unit 105-1 and a deletion threshold computation unit 105-2.

The objective function value computation unit 105-1 computes f(w(k)−wi(k) ei) for each i, where i denotes a variable included in F(k). Here, wi(k) is the i-th element of w(k), and ei is a rule corresponding to the i-th element of w(k). That is, “w(k)−wi(k) ei” is a process of setting the i-th element of w(k) to zero.

The deletion threshold computation unit 105-2 computes a threshold indicating to what extent an objective function increase f(w(k)−wi(k) ei)−f(w(k)) in the case where a variable is deleted is small for the variable to be promising as a deletion candidate. In detail, the deletion threshold computation unit 105-2 computes the threshold by multiplying, by a parameter y where 0≦γ≦λ≦1, the value of f(w(k))−f(w(k−1)) stored in the variable selection result storage unit 103.

The variable selection candidate output device 106 outputs Fp(k) and fj(w(k)) and the addition threshold computed by the addition variable candidate computation unit 104, and/or F(k) and f(w(k)−wi(k) ei) and the deletion threshold computed by the deletion variable candidate computation unit 105, as the variable selection candidate 113.

The variable selection candidate output device 106 can output the variable selection candidate 113 in any form. For example, the variable selection candidate output device 106 may display, on a computer monitor, variables in ascending order of fj(w(k)) not less than the addition threshold, as addition candidates from Fp(k). Moreover, for example, the variable selection candidate output device 106 may display, on the computer monitor, variables in ascending order of f(w(k)−wi(k) ei) not less than the deletion threshold, as deletion candidates from F(k). This method is one output example, and information and thresholds computed by other methods may be output.

The variable selection instruction input device 107 receives a variable to be added from Fp(k) and/or a variable to be deleted from F(k), as the variable selection instruction 114. The number of variables the addition or deletion of which is instructed may be one, or more than one. Though the following description assumes that the number of variables the addition or deletion of which is instructed is one, the same process is applicable even when the number of variables the addition or deletion of which is instructed is more than one.

The optimal variable selection update unit 108 updates the variable selection result, based on the current variable selection result stored in the variable selection result storage unit 103 and the variable selection instruction 114. In detail, in the case where an instruction to add a variable is made, the optimal variable selection update unit 108 deletes the variable from Fp(k), adds the variable to F(k), and sets k=k+1. In the case where an instruction to delete a variable is made, on the other hand, the optimal variable selection update unit 108 deletes the variable from F(k), adds the variable to Fp(k), and sets k=k−1.

The optimal variable selection update unit 108 then optimizes w by minimizing f(w) for updated F(k), and stores updated F(k), Fp(k), and w(k) in the variable selection result storage unit 103. In the case of the variable addition instruction, the optimal variable selection update unit 108 also stores newly computed f(w(k)) in the variable selection result storage unit 103. In the case of the variable deletion instruction, the optimal variable selection update unit 108 deletes f(w(k+1)) stored in the variable selection result storage unit 103.

The variable selection result output device 109 outputs F(k), Fp(k), w(k), f(w), and the like stored in the variable selection result storage unit 103, as the variable selection result 112.

The addition variable candidate computation unit 104 (more specifically, the one-variable optimization unit 104-1 and the addition threshold computation unit 104-2), the deletion variable candidate computation unit 105 (more specifically, the objective function value computation unit 105-1 and the deletion threshold computation unit 105-2), the variable selection candidate output device 106, and the optimal variable selection update unit 108 are, for example, realized by a CPU of a computer operating according to a program (interactive variable selection program).

For instance, the program may be stored in a storage unit (not depicted) in the interactive variable selection device 100, with the CPU reading the program and, according to the program, operating as the addition variable candidate computation unit 104, the deletion variable candidate computation unit 105, the variable selection candidate output device 106, and the optimal variable selection update unit 108. The program may be stored in a computer-readable storage medium.

Alternatively, the addition variable candidate computation unit 104, the deletion variable candidate computation unit 105, the variable selection candidate output device 106, and the optimal variable selection update unit 108 may each be realized by dedicated hardware.

The following describes an operation of the interactive variable selection device 100 in this exemplary embodiment. FIG. 4 is a flowchart depicting an example of the operation of the interactive variable selection device 100 in this exemplary embodiment.

First, the data input device 101 receives the input data 111 (step S100), and stores the received data in the data storage unit 102 (step S101).

Next, the interactive variable selection device 100 initializes the variable selection result (step S102), and stores the initialized variable selection result in the variable selection result storage unit 103 (step S103).

Next, the process of steps S104 to S106 and the process of steps S107 to S109 are performed. The two processes are independent processes, and may be executed simultaneously or in sequence.

The process of steps S104 to S106 is described first.

The one-variable optimization unit 104-1 in the addition variable candidate computation unit 104 selects one variable included in Fp(k), and minimizes f(w) for the variable to compute fj(w(k)) (step S104).

The one-variable optimization unit 104-1 checks whether or not the process of step S104 has been executed for all variables included in Fp(k) (step S105). In the case where the process of step S104 has not been executed for all variables (step S105: No), the one-variable optimization unit 104-1 repeats the process of step S104 until the process is executed for all variables. In the case where the process of step S104 has been executed for all variables (step S105: Yes), on the other hand, the procedure proceeds to step S106.

The addition threshold computation unit 104-2 in the addition variable candidate computation unit 104 computes the threshold for fj(w(k)) of addition candidates (step S106).

The process of steps S107 to S109 is described next.

The objective function value computation unit 105-1 in the deletion variable candidate computation unit 105 selects one variable included in F(k), and computes the value of f(w(k)−wi(k) ei) for the variable (step S107).

The objective function value computation unit 105-1 checks whether or not the process of step S107 has been executed for all variables included in F(k) (step S108). In the case where the process of step S107 has not been executed for all variables (step S108: No), the objective function value computation unit 105-1 repeats the process of step S107 until the process is executed for all variables. In the case where the process of step S107 has been executed for all variables (step S108: Yes), on the other hand, the procedure proceeds to step S109.

The deletion threshold computation unit 105-2 in the deletion variable candidate computation unit 105 computes the threshold for f(w(k)−wi(k) ei)−f(w(k)) of deletion candidates (step S109).

Next, the variable selection candidate output device 106 outputs the variable selection candidate 113 (step S110).

In the case where the variable selection instruction input device 107 receives the variable selection instruction 114 (step S111), the optimal variable selection update unit 108 updates the variable selection result according to the selection instruction (step S112). The updated result is stored in the variable selection result storage unit 103, and the process from step S103 is performed.

The variable selection result output device 109 outputs the variable selection result stored in the variable selection result storage unit 103 as the variable selection result 112, at an arbitrary timing (step S113).

As described above, according to this exemplary embodiment, the addition variable candidate computation unit 104 computes candidates for the variable (addition variable) to be added from Fp(k) to F(k). The optimal variable selection update unit 108 updates w(k) by minimizing f(w) for the variables included in F(k). The deletion variable candidate computation unit 105 computes candidates for the variable (deletion variable) to be deleted from F(k). The variable selection candidate output device 106 then outputs at least one of: the candidates for the addition variable; and the candidates for the deletion variable.

In detail, the one-variable optimization unit 104-1 computes the objective variable value fj(w(k)) in the case where the j-th variable included in Fp(k) is a candidate for the addition variable, and the addition threshold computation unit 104-2 computes, based on fj(w(k)), the threshold (addition threshold) indicating to what extent fj(w(k)) is small for the variable to be promising as an addition candidate. Here, the one-variable optimization unit 104-1 may solve a one-variable optimization problem of minimizing the objective function for wj.

Moreover, the deletion variable candidate computation unit 105 computes the objective function increase f(w(k)−wi(k) ei)−f(w(k)) in the case where the variable wi is deleted, and the deletion threshold computation unit 105-2 computes, based on the objective function increase, the threshold (deletion threshold) indicating to what extent the objective function increase in the case where the variable wi is deleted is small for the variable to be promising as a deletion candidate.

This enables the user to select a more optimal variable from a plurality of selection candidates.

### Exemplary Embodiment 2

FIG. 5 is a block diagram depicting an example of a structure of Exemplary Embodiment 2 of an interactive variable selection device according to the present invention. An interactive variable selection device 200 in this exemplary embodiment differs from the interactive variable selection device 100 in Exemplary Embodiment 1 only in that an addition variable candidate computation unit 201 is connected instead of the addition variable candidate computation unit 104.

FIG. 6 is a block diagram depicting an example of a structure of the addition variable candidate computation unit 201 in this exemplary embodiment. The addition variable candidate computation unit 201 in this exemplary embodiment differs from the addition variable candidate computation unit 104 in Exemplary Embodiment 1 only in that a gradient computation unit 201-1 is connected instead of the one-variable optimization unit 104-1 and an addition threshold computation unit 201-2 is connected instead of the addition threshold computation unit 104-2.

The gradient computation unit 201-1 computes a gradient of f(w) in w(k), for each variable included in Fp(k). The gradient serves as an index indicating to what extent the objective function value can be reduced. An attribute corresponding to a larger absolute gradient value is more promising as an addition candidate. A gradient of f(w) in w(k) relating to the j-th attribute is hereafter denoted by ∇fj(w(k)).

The addition threshold computation unit 201-2 computes a threshold indicating to what extent |∇fj(w(k))| is large for the variable to be promising as an addition candidate. In detail, the addition threshold computation unit 201-2 computes the threshold by multiplying, by a parameter λ where 0≦λ≦1, a mean value of higher-order (K−k) values of |∇fj(w(k))| when arranged in descending order.

The addition variable candidate computation unit 201 (more specifically, the gradient computation unit 201-1 and the addition threshold computation unit 201-2) is, for example, realized by a CPU of a computer operating according to a program (interactive variable selection program).

The following describes an operation of the interactive variable selection device 200 in this exemplary embodiment. FIG. 7 is a flowchart depicting an example of the operation of the interactive variable selection device 200 in this exemplary embodiment.

The operation of the interactive variable selection device 200 depicted in FIG. 7 differs from the operation of the interactive variable selection device 100 depicted in FIG. 4 only in that the process of step S104 (one-variable optimization process) is changed to the process of computing the gradient by the gradient computation unit 201-1 (step S201) and the process of step S106 (addition threshold computation process) is changed to the process of computing the addition threshold based on the gradient by the addition threshold computation unit 201-2 (step S202).

As described above, according to this exemplary embodiment, the gradient computation unit 201-1 computes the gradient of f(w) in w(k), for each variable included in Fp(k). The addition threshold computation unit 201-2 computes the threshold (addition threshold) indicating to what extent |∇fj(w(k))| is large for the variable to be promising as an addition candidate. Here, the gradient computation unit 201-1 may compute the gradient of the objective function in the case where wj is a candidate for the addition variable.

Such a structure enables the user to select a more optimal variable from a plurality of selection candidates, too.

In the interactive variable selection device 100 in Exemplary Embodiment 1, the one-variable optimization unit 104-1 needs to solve the one-variable optimization problem of each variable included in Fp(k). This is effective in the case where the optimization problem can be solved at high speed. For instance, in the case where f(w) is a square loss, high-speed computation is possible because there is a closed-form solution. In the case where the one-variable optimization problem itself is difficult, however, the interactive variable selection device 100 in Exemplary Embodiment 1 requires significant computational cost.

In the interactive variable selection device 200 in this exemplary embodiment, on the other hand, only the gradient for each variable included in Fp(k) is computed in the step corresponding to that in Exemplary Embodiment 1. This method has an advantage of high speed as compared with the case of solving the one-variable optimization problem.

In this method, the objective function cannot be directly evaluated when computing the addition candidates. However, since the computed gradient serves as an index indicating to what extent the objective function value can be reduced, it is possible to objectively evaluate which variable is promising as an addition candidate.

### Exemplary Embodiment 3

FIG. 8 is a block diagram depicting an example of a structure of Exemplary Embodiment 3 of an interactive variable selection device according to the present invention. An interactive variable selection device 300 in this exemplary embodiment differs from the interactive variable selection device 100 in Exemplary Embodiment 1 in that a replacement variable candidate computation unit 301 and a variable replacement instruction input/output device 302 are newly connected, a variable replacement candidate request 311 and a variable replacement instruction 313 are received, and a variable replacement candidate 312 is output.

The variable replacement candidate request 311 is a trigger for designating, from among the variables included in F(k), a variable to be replaced with a variable included in Fp(k), and requesting a process of computing candidates for the replacement variable that is to replace the designated variable.

FIG. 9 is a block diagram depicting an example of a structure of the replacement variable candidate computation unit 301 in this exemplary embodiment. The replacement variable candidate computation unit 301 in this exemplary embodiment includes an optimal variable primary update unit 301-1, a one-variable optimization unit 301-2, and a replacement threshold computation unit 301-3.

The optimal variable primary update unit 301-1 optimizes f(w) only for the variables in F(k) except a variable r that is the variable designated in the variable replacement candidate request 311. Note that the process of optimizing f(w) can be performed by the optimal variable selection update unit 108. Hereafter, a set obtained by excluding the variable r from F(k) is denoted by F*(k, −r), a set obtained by adding the variable r to Fp(k) is denoted by Fp*(k, +r), and w optimized for F*(k, −r) is denoted by w*(k, −r).

The one-variable optimization unit 301-2 performs the same process as the one-variable optimization unit 104-1 in Exemplary Embodiment 1. The one-variable optimization unit 301-2 in this exemplary embodiment, however, differs from the one-variable optimization unit 104-1 in that F*(k, −r) is used instead of F(k), Fp*(k, +r) is used instead of Fp(k), and w*(k, −r) is used instead of w(k).

The replacement threshold computation unit 301-3 computes, as a threshold, a smaller one of: a value obtained by multiplying, by a parameter λ where 0≦λ≦1, a mean value of higher-order (K−k−1) values of fj(w*(k, −r)) when arranged in ascending order; and fr(w*(k, −r)).

The variable replacement instruction input/output device 302 receives the variable replacement candidate request 311, outputs the variable replacement candidate 312, and receives the variable replacement instruction 313.

The variable replacement candidate 312 includes Fp*(k, +r), fj(w*(k, −r)), and the threshold computed by the replacement threshold computation unit 301-3. The variable replacement instruction input/output device 302 can output the variable replacement candidate 312 in any form. For example, the variable replacement instruction input/output device 302 may display, on a computer monitor, variables in ascending order of fj(w*(k, −r)) not less than a replacement threshold, as replacement candidates from Fp*(k, +r).

In the case of receiving the replacement variable as the variable replacement instruction 313, the variable replacement instruction input/output device 302 provides, to the optimal variable selection update unit 108, the variable designated in the variable replacement candidate request 311 as the variable to be deleted, and the variable designated in the variable replacement instruction 313 as the variable to be added.

The replacement variable candidate computation unit 301 (more specifically, the optimal variable primary update unit 301-1, the one-variable optimization unit 301-2, and the replacement threshold computation unit 301-3) and the variable replacement instruction input/output device 302 are, for example, realized by a CPU of a computer operating according to a program (interactive variable selection program).

The following describes an operation of the interactive variable selection device 300 in this exemplary embodiment. FIG. 10 is a flowchart depicting an example of the operation of the interactive variable selection device 300 in this exemplary embodiment. The operation of the interactive variable selection device 300 depicted in FIG. 10 differs from the operation of the interactive variable selection device 100 depicted in FIG. 4 in that steps S300 to S307 are added.

First, the variable replacement instruction input/output device 302 receives the variable replacement candidate request 311 (step S300).

Next, the optimal variable primary update unit 301-1 in the replacement variable candidate computation unit 301 reads the variable selection result stored in the variable selection result storage unit 103 in the process of step S103. The optimal variable primary update unit 301-1 computes F*(k, −r), Fp*(k, +r), and w*(k, −r), while excluding the variable r designated in the variable replacement candidate request 311 (step S301).

Next, the one-variable optimization unit 301-2 in the replacement variable candidate computation unit 301 selects one variable included in Fp*(k, +r), and minimizes f(w) for the variable to compute fj(w*(k, −r)) (step S302).

The one-variable optimization unit 301-2 checks whether or not the process of step S302 has been executed for all variables included in Fp*(k, +r) (step S303). In the case where the process of step S302 has not been executed for all variables (step S303 No), the one-variable optimization unit 301-2 repeats the process of step S302 until the process is executed for all variables. In the case where the process of step S302 has been executed for all variables (step S303: Yes), on the other hand, the procedure proceeds to step S304.

Next, the replacement threshold computation unit 301-3 in the replacement variable candidate computation unit 301 computes the threshold for fj(w*(k, −r)) of replacement candidates (step S304).

Next, the variable replacement instruction input/output device 302 outputs the variable replacement candidate 312 (step S305). The variable replacement instruction input/output device 302 then receives the variable replacement instruction 313 in response to the variable replacement candidate 312 (step S306).

The variable replacement instruction input/output device 302 sets the variable designated in the variable replacement candidate request 311 as the variable to be deleted and the variable designated in the variable replacement instruction 313 as the variable to be added, thus converting the instruction to a selection instruction (step S307). The procedure then proceeds to step S112.

As described above, according to this exemplary embodiment, the optimal variable primary update unit 301-1 optimizes the objective function using F*(k, −r), and the one-variable optimization unit 301-2 computes fj(w*(k, −r)) in the case where the variable wj included in Fp*(k, +r) is a candidate for the addition variable.

The interactive variable selection device 100 in Exemplary Embodiment 1 is provided with two functions of variable addition and variable deletion. Variable replacement can be realized by the combination of these two functions. However, simple replacement causes the following problem.

As an example, consider a situation where a variable i is included in F(k), a variable j is included in Fp(k), and the variable i and the variable j are highly correlated to each other. That is, both variables have the same level of usefulness in terms of reducing the value of f(w).

Suppose the user wants to replace the variable i and the variable j with each other. In the structure of the interactive variable selection device 100, there is a possibility that the variable i is presented as a deletion candidate, while the variable j which is highly correlated to the variable i is determined as not useful as an addition candidate. Thus, there is a possibility that the replacement intended by the user is difficult. This is because, since the variable i is already selected, the variable j having the same information content is not selected as an addition candidate.

On the other hand, the interactive variable selection device 300 in this exemplary embodiment is provided with a function of variable replacement. In the case where the variable i is designated in the variable replacement candidate request, the interactive variable selection device 300 in this exemplary embodiment, while excluding the variable i, outputs each variable having the same level of usefulness as the variable i, as a replacement candidate. This has an advantage of allowing the variable i and the variable j to be replaced with each other.

In other words, the replacement in this exemplary embodiment means that the addition variable candidate i is computed while excluding the designated variable r from F(k).

### Exemplary Embodiment 4

FIG. 11 is a block diagram depicting an example of a structure of Exemplary Embodiment 4 of an interactive variable selection device according to the present invention. An interactive variable selection device 400 in this exemplary embodiment differs from the interactive variable selection device 200 in Exemplary Embodiment 2 in that a replacement variable candidate computation unit 401 and the variable replacement instruction input/output device 302 are newly connected, the variable replacement candidate request 311 and the variable replacement instruction 313 are received, and the variable replacement candidate 312 is output.

The variable replacement instruction input/output device 302 is the same as that in Exemplary Embodiment 3. The variable replacement candidate request 311, the variable replacement instruction 313, and the variable replacement candidate 312 are the same as those in Exemplary Embodiment 3. The replacement variable candidate computation unit 401 corresponds to the replacement variable candidate computation unit 301 in Exemplary Embodiment 3.

That is, the interactive variable selection device 300 in Exemplary Embodiment 3 has the variable replacement function in addition to the interactive variable selection device 100 in Exemplary Embodiment 1, and the interactive variable selection device 400 in this exemplary embodiment has the same variable replacement function in addition to the interactive variable selection device 200 in Exemplary Embodiment 2.

FIG. 12 is a block diagram depicting an example of a structure of the replacement variable candidate computation unit 401 in this exemplary embodiment. The replacement variable candidate computation unit 401 in this exemplary embodiment includes an optimal variable primary update unit 401-1, a gradient computation unit 401-2, and a replacement threshold computation unit 401-3.

The optimal variable primary update unit 401-1 and the replacement threshold computation unit 401-3 are the same as the optimal variable primary update unit 301-1 and the replacement threshold computation unit 301-3 in Exemplary Embodiment 3. The gradient computation unit 401-2 is the same as the gradient computation unit 201-1 in Exemplary Embodiment 2.

### EXAMPLE

The following describes the present invention by way of a specific example, though the scope of the present invention is not limited to the following description. This example relates to the case of performing health risk analysis from health examination logs by applying the interactive variable selection device according to the present invention. An example of applying the interactive variable selection device 100 in Exemplary Embodiment 1 to the medical field is described here.

Modeling the relations between lifestyle habits or health examination values and health or disease risk and performing risk prediction is applicable to disease prevention, risk analysis, lifestyle guidance, and so on.

An excessively complex risk prediction function cannot be understood by humans. It is therefore important to create a risk prediction function with a small number of variables from among input variables (various items of lifestyle habits or health examination values). Predicting with a small number of variables means that variables are sparse as many variables are zero.

Learning a risk score function by a logistic regression model is described below, as an example of the above-mentioned application. The logistic regression model is a method of modeling a risk index (e.g. whether or not blood pressure is higher than a threshold) as a risk probability p (p=1/(1+exp(−wx))), and is typically used in health and medical fields.

An L2 penalized likelihood function is often used in learning the logistic regression model. This corresponds to an objective function satisfying f(w)=Σn log(1+exp(−yn wxn))+λ∥w∥2 in the present invention.

Note that (xn, yn) (n=1, . . . , N) is a learning sample. Here, xn denotes data obtained by vectoring each item of lifestyle habits or health examination values, yn (+1 or −1) denotes whether or not there is risk corresponding to xn, λ denotes an input parameter indicating the strength of the L2 penalized term, and ∥w∥2 denotes the L2 norm of w.

It is possible to automatically learn, from data, a logistic regression model in which many elements of the parameter w are zero and only a small number of risk-related elements are nonzero, by using a commonly known technique. However, for example in the case where obesity and smoking are risk factors of the same level for hypertension, it is difficult to control which factor is selected.

By using the present invention, for example in the case of optimizing a hypertension risk prediction function, a model using only a small number of variables directly linked to the hypertension risk such as body fatness and exercise habits can be computed under control by humans.

The following describes an overview of the present invention. FIG. 13 is a block diagram depicting an overview of an interactive variable selection device according to the present invention. The interactive variable selection device according to the present invention is an interactive variable selection device (e.g. the interactive variable selection device 100) for selecting a variable interactively with a user, the interactive variable selection device including: an addition variable candidate computation unit 70 (e.g. the addition variable candidate computation unit 104) for computing candidates for an addition variable which is a variable to be added from a variable set (e.g. Fp(k)) to a nonzero variable set (e.g. F(k)); an optimal variable selection update unit 90 (e.g. the optimal variable selection update unit 108) for updating variables (e.g. w, w(k)) to be optimized, by minimizing, for variables included in the nonzero variable set, an objective function (e.g. f(w)) that takes a minimum value in optimized variables; a deletion variable candidate computation unit 80 (e.g. the deletion variable candidate computation unit 105) for computing candidates for a deletion variable which is a variable to be deleted from the nonzero variable set; and a variable selection result output unit 60 (e.g. the variable selection result output device 109) for outputting at least one of: the candidates for the addition variable; and the candidates for the deletion variable.

The addition variable candidate computation unit 70 includes: an optimality degree computation unit 71 (e.g. the one-variable optimization unit 104-1, the gradient computation unit 201-1) for computing an optimality degree (e.g. fj(w(k)), |∇fj(w(k))|) in the case where a first variable (e.g. wj) included in the variable set is a candidate for the addition variable, using the objective function; and an addition threshold computation unit 72 (e.g. the addition threshold computation unit 104-2) for computing an addition threshold based on the computed optimality degree, the addition threshold being a threshold of the optimality degree and indicating a criterion for determining whether or not the first variable is to be set as the candidate for the addition variable.

The deletion variable candidate computation unit 80 includes: an objective function value computation unit 81 (e.g. the objective function value computation unit 105-1) for computing an objective function value (e.g. f(w(k)−wi(k) ei)−f(w(k))) which is a difference between a value (e.g. f(w(k)) of the objective function computed using the variables to be optimized and a value (e.g. f(w(k)−wi(k) ei)) of the objective function computed using the variables to be optimized from which a second variable (e.g. wi(k)) included in the nonzero variable set is excluded; and a deletion threshold computation unit 82 (e.g. the deletion threshold computation unit 105-2) for computing a deletion threshold based on the computed objective function value, the deletion threshold being a threshold of the objective function value and indicating a criterion for determining whether or not the second variable is to be deleted from the nonzero variable set.

Such a structure enables the user to select a more optimal variable from a plurality of selection candidates.

In detail, the optimality degree computation unit 71 (e.g. the one-variable optimization unit 104-1) may solve a one-variable optimization problem of minimizing the objective function for the first variable, to compute a value of the objective function as the optimality degree. Such a structure is particularly effective in the case where it is possible to solve the optimization problem at high speed. For example in the case where the objective function represents a square loss, high-speed computation is possible because there is a closed-form solution.

Alternatively, the optimality degree computation unit 71 (e.g. the gradient computation unit 201-1) may compute, for the first variable, a gradient of the objective function in the variables to be optimized, as the optimality degree. With such a structure, only the gradient relating to each variable included in Fp(k) is computed, so that computation can be performed at higher speed in the case where the one-variable optimization problem itself is difficult.

Moreover, the interactive variable selection device may include a replacement variable candidate computation unit (e.g. the replacement variable candidate computation unit 301, the replacement variable candidate computation unit 401) for receiving a variable (e.g. r) that is included in the nonzero variable set and is designated to be replaced with a variable included in the variable set, and computing, from the variable set, candidates for the variable that is to replace the designated variable.

In detail, the replacement variable candidate computation unit may include: an optimal variable primary update unit (e.g. the optimal variable primary update unit 301-1, the optimal variable primary update unit 401-1) for optimizing the objective function using a set of variables (e.g. F*(k, −r)) in which the designated variable is excluded from the candidates for the addition variable; and a replacement threshold computation unit (e.g. the replacement threshold computation unit 301-3, the replacement threshold computation unit 401-3) for computing a replacement threshold based on the computed optimality degree, the replacement threshold being a threshold indicating a criterion for determining whether or not the designated variable is to be replaced with the variable included in the variable set. The optimality degree computation unit 71 (e.g. the one-variable optimization unit 301-2) may then compute the optimality degree (e.g. fj(w*(k, −r)) in the case where the first variable included in the variable set (e.g. Fp*(k, +r)) including the designated variable is the candidate for the addition variable, using the objective function.

With such a structure, even in a situation where two variables are highly correlated to each other, the two variable candidates can be replaced with each other (i.e. one variable is set as a candidate for the addition variable and the other variable is set as a candidate for the deletion variable).

Moreover, the variable selection result output unit 60 may output a variable determined to be the candidate for the addition variable based on the addition threshold, or a variable determined to be deleted from the candidates for the addition variable based on the deletion threshold. Such a structure helps the user objectively determine a variable as an addition candidate.

Moreover, the addition threshold computation unit 72 may specify optimality degrees in order of decreasing optimality degree (e.g. ascending order in the case of fj(w(k)), descending order in the case of |∇fj(w(k))|), and compute, as the addition threshold, a value obtained by multiplying a mean value of the specified optimality degrees by a parameter (e.g. λ where 0≦λ≦1) that is not less than 0 and not more than 1, the optimality degrees being as many as a number (e.g. K−k) obtained by subtracting the number (e.g. k) of variables added to the nonzero variable set from the number (e.g. K) of nonzero elements assumed to remain in the variables to be optimized. The use of this addition threshold enables more appropriate determination of to what extent the created candidate is promising.

Automatic optimization by a machine as described in NPL 1 to NPL 6 is advantageous in that high-precision variable selection is possible if there are a sufficient number of pieces of data, but is disadvantageous in that it is difficult for the user to control the variable selection result.

Besides, in the case of selecting variables using a finite number of pieces of data, a plurality of variable selection results having no statistically significant difference in precision are usually present. It is important to select a favorable result for the user from these variable selection results. Such a selection method is, however, not obvious from automatic variable selection by a machine as described in NPL 1 to NPL 6. The presence of many models having no statistically significant different poses a problem that the user has difficulty in comparing all models and selecting one of them.

A method of ordering variables so that the user selects variables is advantageous in that the user can control the result. However, the typical method has a problem that the criterion for variable ordering does not always conform to the purpose (e.g. optimization of prediction precision). The typical method also has a problem that the user has difficulty in objectively determining up to which variable in the order are reliable variables.

According to the present invention, the user can select a more optimal variable from a plurality of selection candidates.

While the invention has been particularly shown and described with reference to exemplary embodiments thereof, the invention is not limited to these embodiments. It will be understood by those of ordinary skill in the art that various changes in form and details may be made therein without departing from the spirit and scope of the present invention as defined by the claims.

What is claimed is:

1. An interactive variable selection device for selecting a variable interactively with a user, the interactive variable selection device comprising:
an addition variable candidate computation unit for computing candidates for an addition variable which is a variable to be added from a variable set to a nonzero variable set;
an optimal variable selection update unit for updating variables to be optimized, by minimizing, for variables included in the nonzero variable set, an objective function that takes a minimum value in optimized variables;
a deletion variable candidate computation unit for computing candidates for a deletion variable which is a variable to be deleted from the nonzero variable set; and
a variable selection result output unit for outputting at least one of: the candidates for the addition variable; and the candidates for the deletion variable,
wherein the addition variable candidate computation unit includes:
an optimality degree computation unit for computing an optimality degree in the case where a first variable included in the variable set is a candidate for the addition variable, using the objective function; and
an addition threshold computation unit for computing an addition threshold based on the computed optimality degree, the addition threshold being a threshold of the optimality degree and indicating a criterion for determining whether or not the first variable is to be set as the candidate for the addition variable, and
wherein the deletion variable candidate computation unit includes:
an objective function value computation unit for computing an objective function value which is a difference between a value of the objective function computed using the variables to be optimized and a value of the objective function computed using the variables to be optimized from which a second variable included in the nonzero variable set is excluded; and
a deletion threshold computation unit for computing a deletion threshold based on the computed objective function value, the deletion threshold being a threshold of the objective function value and indicating a criterion for determining whether or not the second variable is to be deleted from the nonzero variable set.

2. The interactive variable selection device according to claim 1, wherein the optimality degree computation unit solves a one-variable optimization problem of minimizing the objective function for the first variable, to compute a value of the objective function as the optimality degree.

3. The interactive variable selection device according to claim 1, wherein the optimality degree computation unit computes, for the first variable, a gradient of the objective function in the variables to be optimized, as the optimality degree.

4. The interactive variable selection device according to claim 1, comprising
a replacement variable candidate computation unit for receiving a variable that is included in the nonzero variable set and is designated to be replaced with a variable included in the variable set, and computing, from the variable set, candidates for the variable that is to replace the designated variable.

5. The interactive variable selection device according to claim 2, comprising
a replacement variable candidate computation unit for receiving a variable that is included in the nonzero variable set and is designated to be replaced with a variable included in the variable set, and computing, from the variable set, candidates for the variable that is to replace the designated variable.

6. The interactive variable selection device according to claim 3, comprising
a replacement variable candidate computation unit for receiving a variable that is included in the nonzero variable set and is designated to be replaced with a variable included in the variable set, and computing, from the variable set, candidates for the variable that is to replace the designated variable.

7. The interactive variable selection device according to claim 4, wherein the replacement variable candidate computation unit includes:
an optimal variable primary update unit for optimizing the objective function using a set of variables in which the designated variable is excluded from the candidates for the addition variable; and
a replacement threshold computation unit for computing a replacement threshold based on the computed optimality degree, the replacement threshold being a threshold indicating a criterion for determining whether or not the designated variable is to be replaced with the variable included in the variable set, and
wherein the optimality degree computation unit computes the optimality degree in the case where the first variable included in the variable set including the designated variable is the candidate for the addition variable, using the objective function.

8. The interactive variable selection device according to claim 5, wherein the replacement variable candidate computation unit includes:
an optimal variable primary update unit for optimizing the objective function using a set of variables in which the designated variable is excluded from the candidates for the addition variable; and
a replacement threshold computation unit for computing a replacement threshold based on the computed optimality degree, the replacement threshold being a threshold indicating a criterion for determining whether or not the designated variable is to be replaced with the variable included in the variable set, and
wherein the optimality degree computation unit computes the optimality degree in the case where the first variable included in the variable set including the designated variable is the candidate for the addition variable, using the objective function.

9. The interactive variable selection device according to claim 6, wherein the replacement variable candidate computation unit includes:
an optimal variable primary update unit for optimizing the objective function using a set of variables in which the designated variable is excluded from the candidates for the addition variable; and
a replacement threshold computation unit for computing a replacement threshold based on the computed optimality degree, the replacement threshold being a threshold indicating a criterion for determining whether or not the designated variable is to be replaced with the variable included in the variable set, and
wherein the optimality degree computation unit computes the optimality degree in the case where the first variable included in the variable set including the designated variable is the candidate for the addition variable, using the objective function.

10. The interactive variable selection device according to claim 1, wherein the variable selection result output unit outputs a variable determined to be the candidate for the addition variable based on the addition threshold, or a variable determined to be deleted from the candidates for the addition variable based on the deletion threshold.

11. The interactive variable selection device according to claim 1, wherein the addition threshold computation unit specifies optimality degrees in order of decreasing optimality degree, and computes, as the addition threshold, a value obtained by multiplying a mean value of the specified optimality degrees by a parameter that is not less than 0 and not more than 1, the optimality degrees being as many as a number obtained by subtracting the number of variables added to the nonzero variable set from the number of nonzero elements assumed to remain in the variables to be optimized.

12. An interactive variable selection method for selecting a variable interactively with a user, the interactive variable selection method comprising:
computing candidates for an addition variable which is a variable to be added from a variable set to a nonzero variable set;
updating variables to be optimized, by minimizing, for variables included in the nonzero variable set, an objective function that takes a minimum value in optimized variables;
computing candidates for a deletion variable which is a variable to be deleted from the nonzero variable set; and
outputting at least one of: the candidates for the addition variable; and the candidates for the deletion variable,
wherein when computing the candidates for the addition variable, an optimality degree in the case where a first variable included in the variable set is a candidate for the addition variable is computed using the objective function, and an addition threshold is computed based on the computed optimality degree, the addition threshold being a threshold of the optimality degree and indicating a criterion for determining whether or not the first variable is to be set as the candidate for the addition variable, and
wherein when computing the candidates for the deletion variable, an objective function value which is a difference between a value of the objective function computed using the variables to be optimized and a value of the objective function computed using the variables to be optimized from which a second variable included in the nonzero variable set is excluded is computed, and a deletion threshold is computed based on the computed objective function value, the deletion threshold being a threshold of the objective function value and indicating a criterion for determining whether or not the second variable is to be deleted from the nonzero variable set.

13. The interactive variable selection method according to claim 12, wherein when computing the optimality degree, a one-variable optimization problem of minimizing the objective function for the first variable is solved to compute a value of the objective function as the optimality degree.

14. A non-transitory computer readable information recording medium storing an interactive variable selection program applied to a computer for selecting a variable interactively with a user, when executed by a processor, the interactive variable selection program performs a method for:
computing candidates for an addition variable which is a variable to be added from a variable set to a nonzero variable set;
updating variables to be optimized, by minimizing, for variables included in the nonzero variable set, an objective function that takes a minimum value in optimized variables;
computing candidates for a deletion variable which is a variable to be deleted from the nonzero variable set; and
outputting at least one of: the candidates for the addition variable; and the candidates for the deletion variable,
wherein when computing the candidates for the addition variable, an optimality degree in the case where a first variable included in the variable set is a candidate for the addition variable is computed using the objective function, and an addition threshold is computed based on the computed optimality degree, the addition threshold being a threshold of the optimality degree and indicating a criterion for determining whether or not the first variable is to be set as the candidate for the addition variable, and
wherein when computing the candidates for the deletion variable, an objective function value which is a difference between a value of the objective function computed using the variables to be optimized and a value of the objective function computed using the variables to be optimized from which a second variable included in the nonzero variable set is excluded is computed, and a deletion threshold is computed based on the computed objective function value, the deletion threshold being a threshold of the objective function value and indicating a criterion for determining whether or not the second variable is to be deleted from the nonzero variable set.

15. The non-transitory computer readable information recording medium according to claim 14, wherein when computing the optimality degree, a one-variable optimization problem of minimizing the objective function for the first variable is solved to compute a value of the objective function as the optimality degree.
